(19) United States
(12) Patent Application Publication
(10) Pub. No.: US 2012/0113751 A1
(43) Pub. Date: May 10, 2012

(54) STATICS CALCULATION

(75) Inventor: Alexander Goertz, Zurich (CH)

(73) Assignee: SPECTRASEIS AG, ZURICH (CH)

(21) Appl. No.: 13/383,843

(22) PCT Filed: Jul. 12, 2010
(86) PCT No.: PCT/US10/41738

§ 371 Date: Jan. 13, 2012

Related U.S. Application Data
(60) Provisional application No. 61/224,991, filed on Jul. 13, 2009.
(60) Provisional application No. 61/334,773, filed on May 14, 2010.

(51) Int. Cl. G01V 1/28

(52) U.S. Cl. 367/54

(57) ABSTRACT

A method and system of for determining near surface velocity structure and statics corrections includes acquiring multicomponent seismic data associated with a sensor location, computing spectrograms for all orthogonal components of the multicomponent seismic data using a processing unit, calculating a median H/V spectrum, calculating an initial Rayleigh ellipticity solution associated with the sensor location and inverting the values associated with the median H/V spectrum with a forward-modelled Rayleigh ellipticity solution to determine a velocity depth distribution associated with the sensor location.

### CROSS REFERENCE TO RELATED APPLICATIONS

This application claims the benefit of U.S. Provisional Application No. 61/224,991 filed 13 Jul. 2009 and U.S. Provisional Application No. 61/334,773 filed 14 May 2010 both of which are incorporated herein for all purposes

### BACKGROUND OF THE DISCLOSURE

1. Technical Field

The disclosure is related to seismic exploration for oil and gas, and more particularly to near surface velocity or statics variations related to seismic data processing.

2. Description of the Related Art

Seismic exploration for hydrocarbons generally is conducted using a source of seismic energy and receiving and recording the energy generated by the source using seismic detectors. On land, the seismic energy source may be an explosive charge or another energy source having the capacity to impart impacts or mechanical vibrations at or near the earth's surface. Seismic waves generated by these sources travel into the earth subsurface and are reflected back from boundaries and reach the surface of the earth at varying intervals of time depending on the distance traveled and the characteristics of the subsurface material traversed. The return waves are detected by the sensors and representations of the seismic waves as representative electrical signals are recorded for processing.

Normally, signals from sensors located at varying distances from the source are combined together during processing to produce “stacked” seismic traces. In marine seismic surveys, the source of seismic energy is typically air guns. Marine seismic surveys typically employ a plurality of sources and/or a plurality of streamer cables, in which seismic sensors are mounted, to gather three dimensional data.

The process of exploring for and exploiting subsurface hydrocarbon reservoirs is often costly and inefficient because operators have imperfect information from geophysical and geological characteristics about reservoir locations. Furthermore, a reservoir's characteristics may change as it is produced.

Data acquisition for oil exploration may have a negative impact on the environment. The impact of oil exploration methods on the environment may be reduced by using low-impact methods and/or by narrowing the scope of methods requiring an active source, including reflection seismic and electromagnetic surveying methods.

Geophysical and geological methods are used to determine well locations. Expensive exploration investment is often focused in the most promising areas using relatively slow methods, such as reflection seismic data acquisition and processing. The acquired data are used for mapping potential hydrocarbon-bearing areas within a survey area to optimize exploratory well locations and to minimize costly non-productive wells.

The time from mineral discovery to production may be shortened if the total time required to evaluate and explore a survey area can be reduced by applying selected methods alone or in combination with other geophysical methods. Some methods may be used as a standalone decision tool for oil and gas development decisions when no other data is available. Preferable methods will be economical, have a low environmental impact, and relatively efficient with rapid data acquisition and processing.

Geophysical and geological methods are used to maximize production after reservoir discovery as well. Reservoirs are analyzed using time lapse surveys (i.e. repeat applications of geophysical methods over time) to understand reservoir changes during production.

### SUMMARY

In one embodiment a method and system of for determining near surface statics corrections includes acquiring multicomponent seismic data, determining a spectrogram for the data using a computer processor, calculating time-average V/H or V/T, selecting a frequency minimum and inverting the frequency minimum to determine the statics time correction.

In another embodiment a method and system of for determining near surface velocity structure and statics corrections includes acquiring multicomponent seismic data associated with a sensor location, computing spectrograms for all orthogonal components of the multicomponent seismic data using a processing unit, calculating a median H/V spectrum, calculating an initial Rayleigh ellipticity solution associated with the sensor location and inverting the values associated with the median H/V spectrum with a forward-modelled Rayleigh ellipticity solution to determine a velocity depth distribution associated with the sensor location.

In yet another embodiment a method to determine the structure of the near-surface weathering layer from single-station measurements of ambient noise is made with multi-component broadband sensors. The inverted 1D velocity profiles of the shallow subsurface underneath the recording site are comparable to shallow uphole measurements that are often employed to augment 3D seismic processing in areas of severe statics problems. The method may be verified at some locations by using collocated microtremor and uphole measurements, for example in a middle-eastern sand desert location with considerable near-surface variations that result in severe statics. Using microtremor inversions allows obtaining near-surface information at much lower cost without drilling. Furthermore, the use of broadband seismometers allows extending the inversion to lower frequencies and therefore to deeper depths than what can typically be sensed with uphole measurements. This may provide velocity constraints in an intermediate depth range between the very shallow subsurface seen by the ground roll and the depths where reflection processing allows to constrain velocity information reasonably well.

### BRIEF DESCRIPTION OF THE DRAWINGS

FIG. 1 illustrates Microtremor recording stations and uphole locations;

FIG. 2 illustrates spectrogram displays of 24 hrs of data from a station at the eastern end of the analysed line. Top three rows illustrate the vertical, East, and North component, respectively. Bottom row illustrates the H/V spectral ratio;

FIG. 3 illustrates a spectral histogram over 2 hours of noisy daytime data, which is quasi-stationary in a log-normal sense with the median spectrum used as input for the inversion;

FIG. 4 illustrates the velocity distribution from uphole data with respect to elevation along the profile line indicated in FIG. 1;

FIG. 5 illustrates the velocity distribution inverted from microtremor H/V spectra along the profile line indicated in FIG. 1;

FIG. 6 is a flow chart illustration of a method according to an embodiment of the present disclosure for calculating a static correction;

FIG. 7 illustrates a flow chart related to a method for processing according to an embodiment of the present disclosure;

FIG. 8 illustrates a flow chart related to a method for processing according to an embodiment of the present disclosure for determining a velocity structure associated with a sensor position; and

FIG. 9 illustrates a flow chart related to a method for processing according to an embodiment of the present disclosure for determining a static corrections associated with a sensor position; and

FIG. 10 is diagrammatic representation of a machine in the form of a computer system within which a set of instructions, when executed may cause the machine to perform any one or more of the methods and processes described herein.

### DETAILED DESCRIPTION

Static corrections are a heuristic, but standard process to correct for distortions in the very heterogeneous near-surface weathering layer. Since the geometry of typical seismic reflection surveys for oil & gas exploration are targeting the much deeper reservoirs and lack resolution in the shallow subsurface, knowledge of the near-surface heterogeneity has to be obtained by other means. Velocity information about the shallow subsurface is often obtained by drilling of shallow (10-100 m) boreholes for the purpose of shooting a checkshot VSP survey to obtain velocity information in the top layers, so-called uphole surveys. Knowledge of the weathering velocity distribution obtained in such a manner allows performing a datum static correction to enforce focusing of deeper reflections. It also provides overburden constraints for velocity analysis. Due to their considerable cost (a drilling rig and shooting crew has to be moved around), uphole surveys are only performed when the near-surface heterogeneity is expected to be severe, such as is the case for example in desert areas of the middle East. They are coarsely spaced, typically not more often than every kilometer at the most, and can only provide local constraints in the very vicinity of the drilled hole. Despite being an in-situ measurement, the resulting velocities are estimates only. Uncertainties are due to picking errors, layered interpretation, and the fact that the drilling process always alters the formations close to the borehole.

The estimation of shallow velocity structure from ambient noise is a widespread technique in earthquake engineering to assess site amplification effects of strong earthquake ground motions. The spectral ratio between the horizontal and vertical component (H/V) of a passive or non-controlled source seismic recording exhibits a characteristic modulation indicative of the dispersive Rayleigh wave ellipticity underneath the vicinity of the recording station. If Rayleigh waves are the dominant wave mode in the data, the H/V ratio spectrum can be inverted for the 1D velocity profile underneath the recording site.

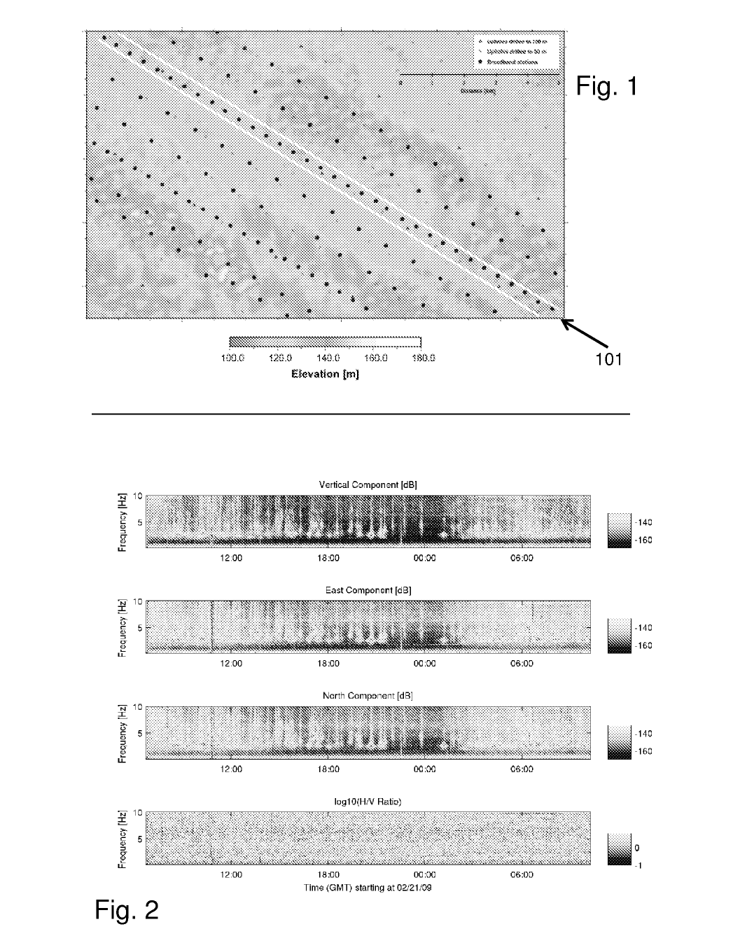

Low-frequency passive or non-controlled source seismic seismic surveys with broadband seismometers allow the determination of near surface (upper few hundreds of meters) velocity structure from the ambient seismic background wave field. For illustration microtremor data from a subset of a large seismic survey in a sand desert is inverted for the shallow velocity variation underneath the recording site from H/V ratio measurements and compared to uphole velocity information obtained at the same locations. The results may then be compared along a collocated profile line (FIG. 1).

Travel time calculations through the inverted velocity profiles and the uphole velocity profiles reveal that long-wavelength components of the receiver statics can be retrieved in survey areas.

An illustrative survey description: The data used here was acquired without an controlled source and with broadband seismometers buried about 0.5 m deep in sand with station spacing between 500 m and 1 km (FIG. 1). Each station records the ambient seismic wave field for several hours, for example 48 hrs. Data in the area for FIG. 1 was acquired synchronously with a sampling rate of 100 Hz. Many different kinds of broadband seismometers may be used. The seismometers used in this illustrative survey have a flat instrument response from 40 s ( 1/40 Hz) to 50 Hz. Each three-component station was leveled and oriented towards North using a magnetic compass. FIG. 2 shows a spectrogram of a station in the SE corner of the survey area.

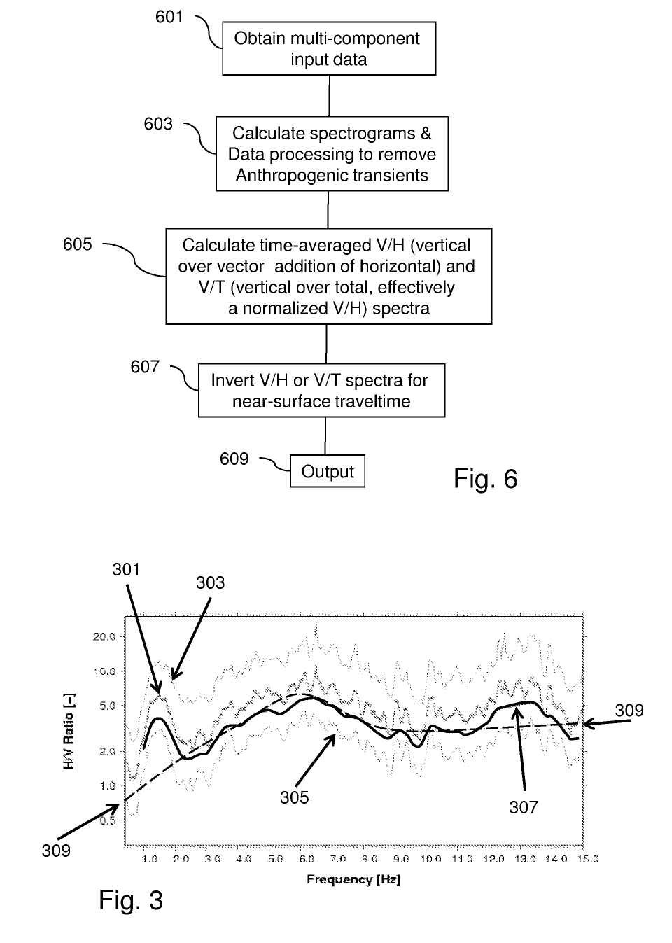

Even though the temporal variation of the ambient seismic wave field is significant on the individual components, the H/V spectral ratio (bottom row) is remarkably stationary over the displayed time period. It is therefore representative of the site response at this location and source signature effects can be neglected in the H/V ratio domain Transient events in FIG. 2 can be attributed to traffic noise from a nearby highway. To mitigate the effect of a possible source signature in the H/V ratio spectra, noisy daytime data may be preferentially used for further analysis. Extremely strong transients and teleseismic earthquakes may temporarily alter the H/V ratio spectra. The data may be scanned for quasi-stationary subsets to use for the inversion. FIG. 3 shows a spectral histogram of two hours of noisy data at daybreak between 5:00 am and 7:00 am local time. The temporal variation is observed to be quasi-stationary in a log-normal sense. Therefore, the median H/V spectrum can be used as a representation of the site response at this receiver.

H/V ratio inversion: The power spectrum of measured particle velocity M(f) at a receiver can be described by a convolutional model as a superposition of many randomly distributed sources,

$$M ( f ) = {\sum }_{i} \{ {E}_{i} ( f ) {P}_{i} ( f ) \} S ( f ) ,$$

where E and P are the source path and propagation path terms of individual noise sources i. The term S describes the site-specific spectral response. Broad band seismometer instrument response can be considered flat over the frequency band used. The cumulative source and propagation path terms of the sum in above equation divide to unity when building the H/V ratio,

$$HV ( f ) = \frac{\sqrt{0.5 * ( {N ( f )}^{2} + {E ( f )}^{2} )}}{Z ( f )} = \frac{{S}_{H} ( f )}{{S}_{V} ( f )}$$

The term S denotes the site response of equation 1 above. Letters N, E and Z denote the North, East and vertical component recording. The above holds true if noise sources are broadband and randomly distributed in the vicinity of the recording location. Some recording sites may exhibit seismic energy from narrow-banded stationary noise sources. These frequency spikes are sometimes still visible in the H/V spectrum. To mitigate the effect of such frequency spikes, the median H/V spectra maybe smoothed before inversion.

For the purpose of velocity inversion from Rayleigh ellipticity ratios, the H/V ratio spectrum may be assumed to be dominated by the fundamental mode Rayleigh wave. Any additional body wave components in the wave field that may occur in specific frequency ranges can be neglected by selecting daytime microtremor data that is dominated by broadband anthropogenic noise. Noise of anthropogenic origin created at the surface can be expected to contain a predominant portion of the energy in surface wave modes. However, the ratio between Rayleigh and Love wave propagation is still unknown. Due to the fact that Love wave particle motion is horizontal, no frequency-dependent tuning effects are expected and the contribution of love waves in the H/V ratio spectrum causes a DC shift to the spectra. There is probably about an equal amount of Love and Rayleigh waves contributing to the H/V spectra. Since Rayleigh and Love waves are polarized normal to each other, the Love wave contribution can be corrected by dividing each spectrum with a constant factor of sqrt(2).

The frequency range used for inversion defines the depth down to which the inversion is sensitive. To estimate a useful frequency range, velocity data from the available upholes may be analyzed. For the data used with this illustration, holes are drilled to an average depth of 50 m in the survey area, with every 5^{th} uphole drilled to a depth of 150 m. Over that range, the largest velocity variation encountered in the in the illustrative data set is in the upper 30 m. P-wave velocities of unconsolidated sands vary between 500 and 1000 m/s, followed by velocities of about 1800 m/s in the sub-weathering layer below. No further differentiation of the sub-weathering velocities was made in the analysis of this illustrative uphole data. In order to be sensitive to the upper 50 m with the indicated velocities, a frequency range of 1 to 15 Hz is selected. A neighborhood algorithm was used for the inversion though many different error minimization algorithms are satisfactory. The algorithm allows inverting for both P- and S-wave velocity, even though the ellipticity spectrum is most sensitive to the shear wave velocity. The resulting ellipticity curve is shown in FIG. 3 for the same station shown in FIG. 2.

FIG. 3 illustrates an ellipticity curve with the median H/V ratio 301 and the 16th percentile 303 and 84th percentile 305. The solid line is the smoothed median divided by sqrt(2) 307 that is input to the inversion and the forward-modelled Rayleigh ellipticity of the inversion result is shown as the dashed line 309. An initial Rayleigh ellipticity profile may be estimated or calculated from known information or velocity information from one uphole survey position.

The gross features of the median H/V spectrum are well matched. The selection of a starting velocity model was guided by one uphole location and the model depth was restricted to the upper 200 m. A distinct peak between 1 and 2 Hz is not matched by the inversion result. This peak is due to a deeper velocity contrast. Extending the inversion to lower frequencies allows estimating velocities at greater depths, albeit with increasing uncertainty. Lower frequencies can be used in this case because broadband seismometers are used.

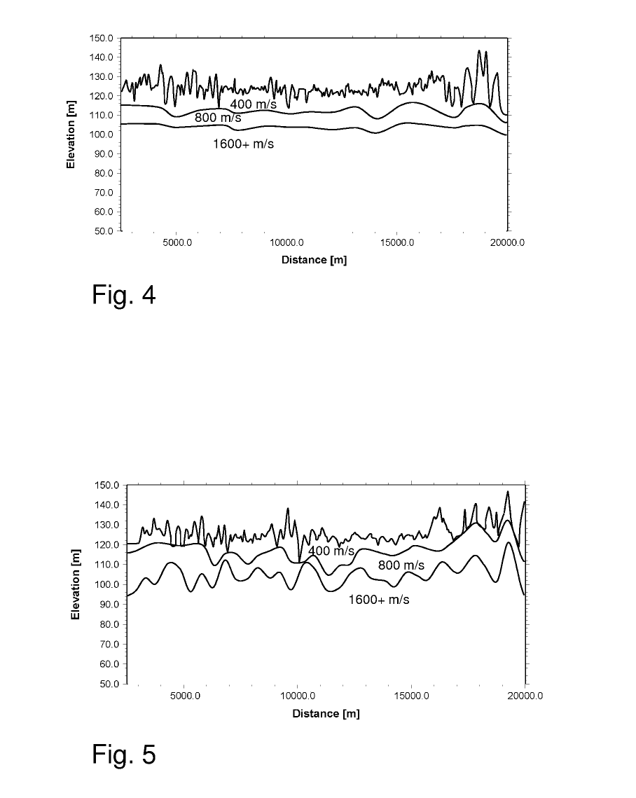

Comparison to uphole velocities: FIG. 4 shows a velocity interpretation compiled from all upholes along the profile 101 outlined in FIG. 1. For comparison, FIG. 5 shows a velocity interpretation from the inverted velocity-depth functions for all seismometer stations along this profile. Along this profile, uphole information was available every kilometer, whereas microtremor measurements were performed with a station spacing of 500 m. The top line in both FIG. 4 and FIG. 5 denote the ground surface elevation of a straight line through all upholes, and seismic stations respectively. Since the acquisition locations on each of the two lines are not collocated, the elevation profiles are different between figures. Only P-wave velocities are compared since only P-wave velocity information was available from the uphole data. The uphole velocity profile shows a strong velocity contrast at an elevation between 100 m and 110 m a.s.l. that is more or less flat across the profile. The surface topography in this area is primarily comprised of sand and sand dunes. The inverted velocities show a comparable variation with overall the same velocities. The strong velocity contrast between 100 and 110 m a.s.l. is captured well by the H/V inversion. The inversion from H/V spectra produces velocity and information for statics corrections comparable to upholes without the need for drilling.

Inverting shallow velocity information from single-station broadband measurements of the ambient wave field provides information similar to the cost-intensive drilling of upholes at a much lower effort. Typically, a few hours of daytime measurements are sufficient to derive a representative estimate of the site response spectra. Data can be acquired independently from each other, and the presence of anthropogenic noise in the data may provide for a better solution. In addition to being much cheaper, the inversion can provide near-surface shear wave velocity information. By extending the inversion to lower frequencies, the method provides velocity estimates in an intermediate depth range between the weathering layer and the typical depth where velocity analysis gives reliable results. When deployed during a 3D seismic campaign, broadband sensors can provide valuable low-frequency constraints for waveform inversion techniques.

Information for determining long period statics corrections for seismic data may be extracted from naturally occurring seismic waves and vibrations measured at the earth's surface. These naturally occurring waves may be measured using seismic data acquisition methods to acquire naturally occurring background seismic data. Peaks or troughs in the spectral ratio between the vertical and the horizontal components of the background waves may be inverted to determine statics corrections.

Passive or non-controlled source seismic data acquisition methods rely on seismic energy from sources not directly associated with the data acquisition. Examples of low frequency ambient waves that may be recorded with passive seismic acquisition are microseisms (e.g., rhythmically and persistently recurring low-frequency earth tremors), microtremors and other anthropogenic or localized seismic energy sources.

Microtremors are attributed to the background energy present in the earth that may be due to non-seismic sources or anthropogenic noise. Microtremor seismic waves may include sustained seismic signals within a limited frequency range. Microtremor signals, like all seismic waves, contain information affecting spectral signature characteristics due to the media or environment that the seismic waves traverse. These naturally occurring relatively low frequency background seismic waves (sometimes termed noise or hum) of the earth may be generated from a variety sources, some of which may be indeterminate.

One or more sensors are used to measure vertical and horizontal components of motion due to background seismic waves at multiple locations within a survey area. These components may be measured separately or in combination and may be recorded as signals representing displacement, velocity, and/or acceleration.

The sensors may measure the components of motion simultaneously or asynchronously. As the spectral ratio of the acquired signal for any location may be quite stable over time, the components of motion may not need to be measured simultaneously. This may be especially applicable in areas with relatively low local ambient wave energy and for data acquired over relatively short time periods (e.g., a few weeks). Spectral ratios determined from asynchronous components at a location may be used as it is the relative difference of spectral components as opposed to specific contemporaneous differences that may be indicative of reservoir characteristics. However, due to anthropogenic or localized seismic energy generated in the vicinity of the seismic survey not related to subsurface reservoirs, relative quiescent periods free of this local anthropogenic seismic energy wherein orthogonal data components are substantially contemporaneously acquired may provide better quality data for delineating subsurface characteristics.

The spectral ratio of vertical to horizontal data components may be calculated to obtain a ratio of at least one horizontal component over the vertical component (a H/V ratio), or the vertical component over at least one horizontal component (a V/H spectral ratio). Characteristics of spectral ratio data may be mapped, for example by plotting geographically and contouring the values. Peaks (or troughs) representative of anomalies may be used to calculate static corrections.

The sensor equipment for measuring seismic waves may be any type of seismometer. Seismometer equipment having a large dynamic range and enhanced sensitivity compared with other transducers may provide the best results (e.g., multicomponent earthquake seismometers). A number of commercially available sensors utilizing different technologies may be used, e.g. a balanced force feed-back instrument or an electrochemical sensor. An instrument with high sensitivity at very low frequencies and good coupling with the earth enhances the efficacy of the method.

Ambient noise conditions representative of seismic wave energy can negatively affect the recorded data. Techniques for removing unwanted artifacts and artificial signals from the data, such as cultural and industrial noise, are important for applying this method successfully in areas where there is high ambient noise.

The spectral ratio method has several advantages over conventional seismic data acquisition for exploration including that the technique does not require an artificial seismic source, such as an explosion, mechanically generated vibration or electric current. Additionally, the results from spectral analysis are repeatable. There is little or no environmental impact due to data acquisition. The method is applicable for land, transition zones and marine areas. The method has application in areas where higher frequencies are greatly affected by geological conditions, e.g. in areas where soft soil layers attenuate high-frequency seismic signals as well as areas where salt formations or volcanic bodies (e.g. basalt flows, volcanic sills) scatter or obscure higher frequencies.

Spectral ratio analysis may take advantage of the selective absorption and hydrocarbon induced relative amplification of relatively low-frequency seismic background waves to enable mapping spectral difference that directly indicate hydrocarbon reservoirs.

The spectral ratio of the horizontal over the vertical components (H/V ratio) of seismic background waves has been used as an indicator for soft soil layers and other near-surface structures. Soft soil resonance effects visible in H/V spectra often occur at frequencies (up to 20 Hz).

FIG. 6 is a schematic illustration of a method according to an embodiment of the present disclosure using passively acquired naturally occurring background seismic data to determine static shifts from ambient seismic measurements to correct seismic reflection data for the distortion imposed by “long period” static variations in the near surface. The embodiment, which may include one or more of the following referenced components (in any order), is a method of determining statics corrections for seismic data that includes obtaining seismic data having a plurality of components 601. The acquired data may be time stamped and include multiple data vectors. An example is multicomponent earthquake type seismometry data, which includes recordings of low-frequency seismic background waves as differentiated from localized or anthropogenic energy related seismicity. The multiple data vectors may each be associated with an orthogonal direction of movement. Data may be acquired in, or mathematically rotated into, orthogonal component vectors arbitrarily designated east, north and depth (respectively, Ve, Vn and Vz) or designated according to desired convention.

The ambient seismic energy may be recorded with sensors spaced on a coarse grid, for example 500 meter to 1 kilometer spacing. The spacing of the measurement points depends on the expected wavelength of the statics (e.g., dune/topography length & height, topographic relief, surface geology, etc.). The embodiment is particularly well suited for determination of the long-wavelength component of the statics (several km). It may be beneficial to apply a residual static correction for the short wavelengths (for example 3-5 times the receiver spacing of a conventional 3D seismic survey) by other means. However, the shorter the wavelength of the statics, the more it can be expected to be surface consistent. At the long wavelengths, it is typically difficult to separate a surface-consistent part of statics correction or solution from a model-dependent part of statics correction or solution. Here, the method is useful for replacing the procedure to drill uphole wells every 1 km.

Calculate spectrograms & data processing to remove anthropogenic transients 603. Nearby sources (transient and stationary) may contaminate the spectra with the source signature. Time periods and spectral bands that are dominated from nearby sources need to be removed. After that, the spectra can be considered to represent the effect of the ground in the vicinity of the measurement point.

A data transform may be applied to each component of the vector data. Seismic data frequency content often varies with time. Time-frequency decomposition (spectral decomposition) of a seismic signal enables analysis and characterization of the signal time-dependent frequency response due to subsurface materials.

Various data transformations are useful for time-frequency analysis of seismic signals, such as continuous or discrete Fourier or wavelet transforms. Examples include without limitation the classic Fourier transform or one of the many continuous Wavelet transforms (CWT) or discreet wavelet transforms. Examples of other transforms include Haar transforms, Haademard transforms and wavelet transforms. The Morlet wavelet is an example of a wavelet transform that may be applied to seismic data. Wavelet transforms have the attractive property that the corresponding expansion may be differentiable term by term when the seismic trace is smooth. Additionally, signal analysis, filtering, and suppressing unwanted signal artifacts may be carried out efficiently using transforms applied to the acquired data signals.

One or more orthogonal components of the acquired data may be merged, for example the horizontal data components. Horizontal components Ve and Vn may be merged by any of several ways including a root-mean-square average so that horizontal component H may be defined as H=\sqrt{(Vₑ²+Vₙ²)/2}. Whether merging data components is undertaken before or after a data transform is applied to the data is a matter of choice.

Additionally the spectra may be smoothed using a moving average. The smoothing parameter defines the width of the window (in Hz) used for calculating moving averages. A large smoothing parameter leads to strong smoothing and a small smoothing parameter leads to less smoothing. Typical values may be between 0.1 Hz and 2 Hz, but will be case dependent. A smoothing parameter for a flow may be selected at the beginning of a processing flow for application prior to calculating a spectral ratio.

Calculate time-averaged V/H (vertical over vector addition of horizontal) and V/T (vertical over total, effectively a normalized V/H) spectra 605. The inversion of near-surface layering is often done using the H/V spectral ratio. Using the V/H for inversion offers the advantage of avoiding a pole. Using V/T is effectively a normalization of the V/H which is also advantageous for an inversion. The T in the V/T ratio is calculated as the square root of the sum of the squares of all three orthogonal components.

Invert V/H or V/T spectra for near-surface traveltime 607. Alternative 1 is to a pick frequency minimum in V/H or V/T. The frequency of the minimum in V/H or V/T. The frequency of the minimum relates to v/4*h, v=velocity, h=thickness; its inverse relates to 4*T, T=traveltime through shallow layer=value of site specific static shift. Alternative 2 is a least square LS QR of V/H response of forward-modelled fundamental-mode Rayleigh wave (layer over half space) in selected frequency range to invert for T.

The method may be calibrated by drilling one uphole well (instead of hundreds) to find suitable model for forward modeling of fundamental mode Rayleigh wave.

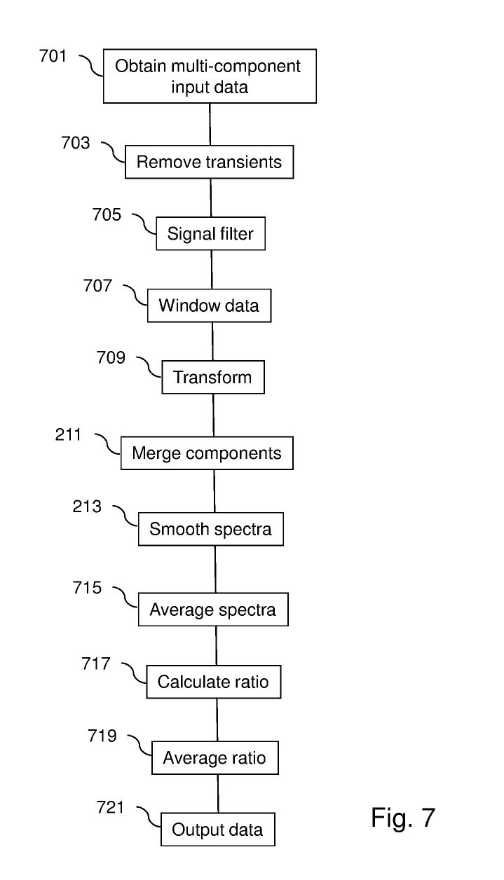

FIG. 7 illustrates an embodiment, which may include one or more of the referenced components (in any order), for determining long period statics corrections. Seismic data that has a plurality of components 701 are obtained. The data may include a time stamp vector and orthogonal data vectors. The data vectors may be all same length and synchronized. The components may be orthogonal vector data representing two horizontal directions and a vertical direction.

The multicomponent input data may be cleaned to remove transients 703. One way to remove transients is to process data when transients are not present. Signal filtering 705 with the time domain data include frequency filtering and bias removal. The data may be detrended so that one or more linear trends are removed. The data may be band pass filtered or a DC offset bias removed as well.

The data may be divided into time windows 707. The time window length for data vectors may be chosen based on operational or processing considerations, and an example length may correspond to 10 cycles of the lower frequency range of interest. Horizontal data components may be merged, for example by averaging or by a root-mean-square weighting of the values.

Data may be rotated to any desired reference frame. A reference frame where the vertical vector direction is normal to the geoid may be beneficial for subsequent formation of V/H spectral ratios. The spectra may be smoothed, for example with a moving average function. The data may be decomposed into spectral components 709 by any time-frequency decomposition, e.g., Fourier or Wavelet transform.

One or more orthogonal components of the obtained data may be merged 711, for example the horizontal data components. Horizontal components Ve and Vn may be merged by any of several ways including a geometrical means like the root-mean-square average so that horizontal component H may be defined as H=\sqrt{(Vₑ²+Vₙ²)/2}. Other methods for merging including using an arithmetic mean, a Pythagorean mean or a complex Fourier transformation.

The spectra may be smoothed 713 using a low pass filter, a moving window with a fixed bandwidth or a variable bandwidth. The spectra may be averaged 715 using an arithmetic mean or a geometric mean.

A spectral ratio is determined between transformed components 717. The spectral ratio may be determined with point-by-point spectral division, for example determining spectral ratios between horizontal and vertical data. A V/H spectral ratio may be determined using the vertical component with one or both horizontal components, or a merged version of the horizontal components. The spectral ratio may be averaged 719 as well, using an arithmetic or geometric mean. The calculated ratio may be stored 721 (to a computer readable media).

While data may be acquired with broadband sensors with large dynamic range and enhanced sensitivity, many different types of sensor instruments can be used with different underlying technologies and varying sensitivities. Sensor positioning during recording may vary, e.g. sensors may be positioned on the ground, below the surface or in a borehole. The sensor may be positioned on a tripod or rock pad. Sensors may be enclosed in a protective housing for ocean bottom placement. Wherever sensors are positioned, good coupling results in better data. Recording time may vary, e.g. from minutes to hours or days. In general terms, longer-term measurements may be helpful in areas where there is high ambient noise (representative of wave energy not traversing a subsurface hydrocarbon reservoir) and provide extended periods of data with fewer noise problems.

The layout of a survey may be varied, e.g. measurement locations may be close together or spaced widely apart and different locations may be occupied for acquiring measurements consecutively or simultaneously. Simultaneous recording of a plurality of locations may provide for relative consistency in environmental conditions that may be helpful in ameliorating problematic or localized ambient noise not related to subsurface characteristics.

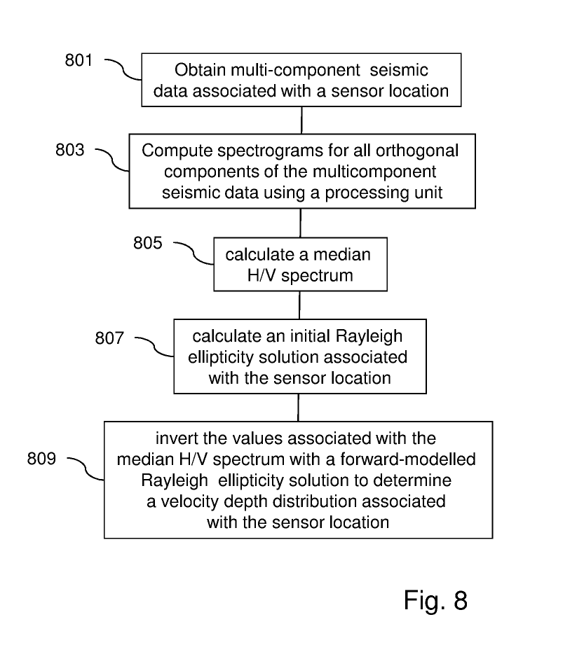

FIG. 8 illustrates a method of determining a velocity structure associated with a multicomponent sensor position. Multicomponent seismic data associated with a sensor position is obtained 801. Spectragrams are computed for the components of the multicomponent data 803. A median H/V (or V/H) spectrum is calculated 805. The square root of 2 may be subtracted from the median H/V. An initial Rayleigh ellipticity solution associated with the sensor position is calculated 807. The values associated with the median H/V spectrum are inverted 809 along with the initial Rayleigh ellipticity solution spectrum values and the inversion iterated until the Rayleigh ellipticity solution is minimized compared with the median H/V spectrum as illustrated with respect to FIG. 3 lines 307 and 309. The final Rayleigh ellipticity solution wherein the inversion differences are minimized then represents the velocity depth distribution associated with the location of the multicomponent sensor.

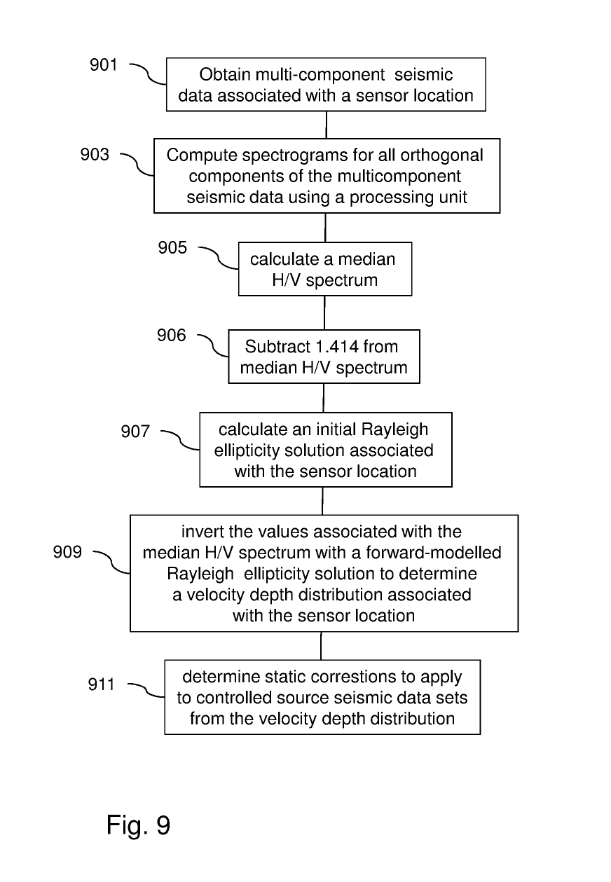

FIG. 9 illustrates a method of determining a velocity structure associated with a multicomponent sensor position. Multicomponent seismic data associated with a sensor position is obtained 901. Spectragrams are computed for the components of the multicomponent data 903. A median H/V (or V/H) spectrum is calculated 905. The square root of 2 may be subtracted 906 from the median H/V. An initial Rayleigh ellipticity solution associated with the sensor position is calculated 907. The values associated with the median H/V spectrum are inverted 909 along with the initial Rayleigh ellipticity solution spectrum values and the inversion iterated until the Rayleigh ellipticity solution is minimized compared with the median H/V spectrum as illustrated with respect to FIG. 3 lines 307 and 309. The final Rayleigh ellipticity solution wherein the inversion differences are minimized then represents the velocity depth distribution associated with the location of the multicomponent sensor. The velocity depth distribution may be used to determine static corrections to apply to controlled source seismic data sets, such and convention 2D and 3D reflection seismic data sets.

In one nonlimiting embodiment a method of determining near a surface velocity structure comprises acquiring multicomponent seismic data associated with a sensor location, computing spectrograms for all orthogonal components of the multicomponent seismic data using a processing unit, calculating a median H/V spectrum, calculating an initial Rayleigh ellipticity solution associated with the sensor location and inverting the values associated with the median H/V spectrum with a forward-modelled Rayleigh ellipticity solution to determine a velocity depth distribution associated with the sensor location. The differences between the the median H/V spectrum with a forward-modelled Rayleigh ellipticity solution are minimized to determine a velocity depth distribution associated with the sensor location.

In another aspect the method may comprise dividing the median H/V spectrum by the square root of 2. In still another aspect the multicomponent seismic data are acquired without a controlled source. The initial Rayleigh ellipticity solution may be calculated with data from an uphole seismic survey or estimated. In yet another aspect the method comprises determining static corrections to apply to controlled source seismic data from the velocity depth distribution associated with the sensor location. The statics time correction may be stored in a form for display.

In another nonlimiting embodiment an information handling system for determining a velocity depth distribution associated with a multicomponent sensor position comprises a processor configured for computing spectrograms for orthogonal components of multicomponent seismic data, and for calculating a median H/V spectrum and for performing an inversion to minimize the difference between median H/V spectrum and a forward-modelled Rayleigh ellipticity solution to determine a velocity depth distribution associated with the sensor location. A computer readable medium is provided for storing the velocity depth distribution associated with the sensor location.

In another aspect the processor of the information handling system of claim 7 is configured for dividing the median H/V spectrum by the square root of 2. In still another aspect the information handling system comprises a display device for displaying a long period wavelength solution from a plurality of velocity depth distributions. In yet another aspect the multicomponent seismic data are acquired without a controlled source. Determining the initial Rayleigh ellipticity solution may be calculated with data from an uphole seismic survey. In another aspect the information handling system further comprises determining static corrections to apply to controlled source seismic data from the velocity depth distribution associated with the sensor location. The statics time correction may be stored on computer readable media in a form for display. A graphical display coupled to the processor may be configured to present a view of the statics time corrections or the velocity depth distribution.

A set of application program interfaces embodied on a computer readable medium which, when executed on a processor in conjunction with an application program, cause the processor to perform a method for determining a statics time correction for seismic data, wherein the method comprises: a first interface that receives multicomponent seismic data associated with a sensor location; a second interface for computing spectrograms for orthogonal components of the multicomponent seismic data; a third interface for computing a smoothed H/V median divided by a square-root of 2; and a fourth interface calculating an initial Rayleigh ellipticity solution associated with the sensor location and a fifth interface for inverting the values associated with the median H/V spectrum with a forward-modelled Rayleigh ellipticity solution to determine a velocity depth distribution associated with the sensor location.

In another aspect the set of application interface programs further comprises determining the initial Rayleigh ellipticity solution with data from an uphole seismic survey. In still another aspect the multicomponent seismic data are acquired without a controlled source. In yet another aspect static corrections to apply to controlled source seismic data are determined from the velocity depth distribution associated with the sensor location. The static corrections may be stored in a form for display. A graphical display coupled to a processor may be configured to present a view of the velocity depth distribution or the static corrections.

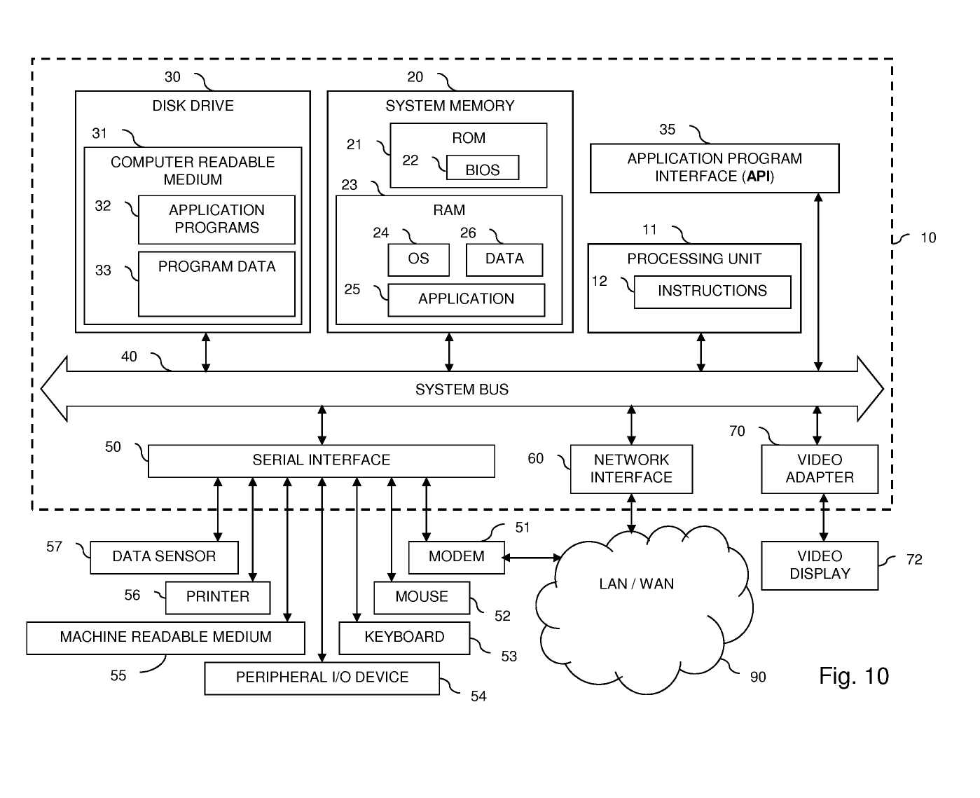

FIG. 10 illustrates a schematic example of the hardware and operating environment for which embodiments as described herein and their equivalents may be practiced. The description of FIG. 10 includes a general description of computer hardware, computing environment or information handling system for which the embodiments may be implemented. Although specific hardware may not be required, embodiments may be implemented in the general context of computer-executable instructions, such as program modules, being executed by a computer. Various embodiments may be practiced with a personal computer, a mainframe computer or combinations that include workstations with servers. Program modules include routines, programs, objects, components and data structures for performing tasks, processing data, and recording and displaying information.

The products as defined herein may be particularly adapted for use in what are termed “information handling system.” An information handling system is any instrumentality or aggregate of instrumentalities primarily designed to compute, classify, process, transmit, receive, retrieve, originate, switch, store, display, manifest, measure, detect, record, reproduce, handle or utilize any form of information, intelligence or data for business, scientific, control or other purposes. Examples include personal computers and larger processors such as servers, mainframes, etc, and may contain elements illustrated in FIG. 10.

Embodiments may be practiced with various computer or information handling system configurations that separately or in combination may include hand-held devices, multiprocessor systems, microprocessor-based or programmable consumer electronics, network computers, minicomputers, mainframe computers, and the like. Embodiments may be practiced with tasks performed in and over distributed computing environments that include remote processing devices linked through a communications network. Program modules operating in distributed computing environments may be located in various memory locations, both local and remote.

FIG. 10 is illustrative of hardware and an operating environment for implementing a general purpose computing device or information handling system in the form of a computer 10. Computer 10 includes a processor or processing unit 11 that may include ‘onboard’ instructions 12. Computer 10 has a system memory 20 attached to a system bus 40 that operatively couples various system components including system memory 20 to processing unit 11. The system bus 40 may be any of several types of bus structures using any of a variety of bus architectures as are known in the art.

While one processing unit 11 is illustrated in FIG. 10, there may be a single central-processing unit (CPU) or a graphics processing unit (GPU), or both or a plurality of processing units. Computer 10 may be a standalone computer, a distributed computer, or any other type of computer.

System memory 20 includes read only memory (ROM) 21 with a basic input/output system (BIOS) 22 containing the basic routines that help to transfer information between elements within the computer 10, such as during start-up. System memory 20 of computer 10 further includes random access memory (RAM) 23 that may include an operating system (OS) 24, an application program 25 and data 26.

Computer 10 may include a disk drive 30 to enable reading from and writing to an associated computer or machine readable medium 31. Computer readable media 31 includes application programs 32 and program data 33.

For example, computer readable medium 31 may include programs to process seismic data, which may be stored as program data 33, according to the methods disclosed herein. The application program 32 associated with the computer readable medium 31 includes at least one application interface for receiving and/or processing program data 33. The program data 33 may include seismic data acquired according to embodiments disclosed herein. At least one application interface may be associated with determining velocity structure or calculating statics computations from combinations of spectral components for more accurately processing surface seismic data.

The disk drive may be a hard disk drive for a hard drive (e.g., magnetic disk) or a drive for a magnetic disk drive for reading from or writing to a removable magnetic media, or an optical disk drive for reading from or writing to a removable optical disk such as a CD ROM, DVD or other optical media.

Disk drive 30, whether a hard disk drive, magnetic disk drive or optical disk drive is connected to the system bus 40 by a disk drive interface (not shown). The drive 30 and associated computer-readable media 31 enable nonvolatile storage and retrieval for one or more application programs 32 and data 33 that include computer-readable instructions, data structures, program modules and other data for the computer 10. Any type of computer-readable media that can store data accessible by a computer, including but not limited to cassettes, flash memory, digital video disks in all formats, random access memories (RAMs), read only memories (ROMs), may be used in a computer 10 operating environment.

The application programs 32 may be associated with one or more application program interfaces. An application programming interface (API) 35 may be an interface that a computer system, library or application provides in order to allow requests for services to be made of it by other computer programs, and/or to allow data to be exchanged between them. An API 35 may also be a formalized set of software calls and routines that can be referenced by an application program 32 in order to access supporting application programs or services, which programs may be accessed over a network 90.

APIs 35 are provided that allow for higher level programming for displaying and mapping subsurface reservoirs. For example, APIs are provided for receiving seismic data, and decomposing, merging, smoothing and averaging the data. Moreover, the APIs allow for receiving the velocity structure or statics data and storing it for display.

Data input and output devices may be connected to the processing unit 11 through a serial interface 50 that is coupled to the system bus. Serial interface 50 may a universal serial bus (USB). A user may enter commands or data into computer 10 through input devices connected to serial interface 50 such as a keyboard 53 and pointing device (mouse) 52. Other peripheral input/output devices 54 may include without limitation a microphone, joystick, game pad, satellite dish, scanner or fax, speakers, wireless transducer, etc. Other interfaces (not shown) that may be connected to bus 40 to enable input/output to computer 10 include a parallel port or a game port. Computers often include other peripheral input/output devices 54 that may be connected with serial interface 50 such as a machine readable media 55 (e.g., a memory stick), a printer 56 and a data sensor 57. A seismic sensor or seismometer for practicing embodiments disclosed herein are nonlimiting examples of data sensor 57. A video display 72 (e.g., a liquid crystal display (LCD), a flat panel, a solid state display, or a cathode ray tube (CRT)) or other type of output display device may also be connected to the system bus 40 via an interface, such as a video adapter 70. A map display created from statics or time delay values as disclosed herein may be displayed with video display 72.

A computer 10 may operate in a networked environment using logical connections to one or more remote computers. These logical connections are achieved by a communication device associated with computer 10. A remote computer may be another computer, a server, a router, a network computer, a workstation, a client, a peer device or other common network node, and typically includes many or all of the elements described relative to computer 10. The logical connections depicted in FIG. 10 include a local-area network (LAN) or a wide-area network (WAN) 90. However, the designation of such networking environments, whether LAN or WAN, is often arbitrary as the functionalities may be substantially similar. These networks are common in offices, enterprise-wide computer networks, intranets and the Internet.

When used in a networking environment, the computer 10 may be connected to a network 90 through a network interface or adapter 60. Alternatively computer 10 may include a modem 51 or any other type of communications device for establishing communications over the network 90, such as the Internet. Modem 51, which may be internal or external, may be connected to the system bus 40 via the serial interface 50.

In a networked deployment computer 10 may operate in the capacity of a server or a client user machine in server-client user network environment, or as a peer machine in a peer-to-peer (or distributed) network environment. In a networked environment, program modules associated with computer 10, or portions thereof, may be stored in a remote memory storage device. The network connections schematically illustrated are for example only and other communications devices for establishing a communications link between computers may be used.

While various embodiments have been shown and described, various modifications and substitutions may be made thereto without departing from the spirit and scope of the disclosure herein. Accordingly, it is to be understood that the present embodiments have been described by way of illustration and not limitation.

We claim:

1. A method of determining near a surface velocity structure comprising:
acquiring multicomponent seismic data associated with a sensor location; computing spectrograms for all orthogonal components of the multicomponent seismic data using a processing unit; calculating a median H/V spectrum; calculating an initial Rayleigh ellipticity solution associated with the sensor location; and inverting the values associated with the median H/V spectrum with a forward-modelled Rayleigh ellipticity solution to determine a velocity depth distribution associated with the sensor location.

2. The method of claim 1 further comprising dividing the median H/V spectrum by the square root of 2.

3. The method of claim 1 wherein the multicomponent seismic data are acquired without a controlled source.

4. The method of claim 1 further comprising determining the initial Rayleigh ellipticity solution with data from an uphole seismic survey.

5. The method of claim 1 further comprising determining static corrections to apply to controlled source seismic data from the velocity depth distribution associated with the sensor location.

6. The method of claim 5 further comprising storing the statics time correction in a form for display.

7. An information handling system for determining a velocity depth distribution associated with a multicomponent sensor position comprising: a processor configured for computing spectrograms for orthogonal components of multicomponent seismic data, calculating a median H/V spectrum and performing an inversion to minimize the difference between median H/V spectrum and a forward-modelled Rayleigh ellipticity solution to determine a velocity depth distribution associated with the sensor location; and a computer readable medium for storing the velocity depth distribution associated with the sensor location.

8. The information handling system of claim 7 wherein the processor is configured for dividing the median H/V spectrum by the square root of 2.

9. The information handling system of claim 7 further comprising a display device for displaying a long period wavelength solution from a plurality of velocity depth distributions.

10. The information handling system of claim 7 wherein the multicomponent seismic data are acquired without a controlled source.

11. The information handling system of claim 7 further comprising determining the initial Rayleigh ellipticity solution with data from an uphole seismic survey.

12. The information handling system of claim 7 further comprising determining static corrections to apply to controlled source seismic data from the velocity depth distribution associated with the sensor location.

13. The information handling system of claim 12 further comprising storing the statics time correction in a form for display.

14. The information handling system of claim 7 further comprising: a graphical display coupled to the processor and configured to present a view of the velocity depth distribution.

15. A set of application program interfaces embodied on a computer readable medium which, when executed on a processor in conjunction with an application program, cause the processor to perform a method for determining a statics time correction for seismic data, wherein the method comprises: a first interface that receives multicomponent seismic data associated with a sensor location; a second interface for computing spectrograms for orthogonal components of the multicomponent seismic data; a third interface for computing a smoothed H/V median divided by a square-root of 2; and a fourth interface calculating an initial Rayleigh ellipticity solution associated with the sensor location and a fifth interface for inverting the values associated with the median H/V spectrum with a forward-modelled Rayleigh ellipticity solution to determine a velocity depth distribution associated with the sensor location.

16. The set of application interface programs according to claim 15 further comprising:
determining the initial Rayleigh ellipticity solution with data from an uphole seismic survey.

17. The set of application interface programs according to claim 15 wherein the multicomponent seismic data are acquired without a controlled source.

18. The set of application interface programs according to claim 15 further comprising determining static corrections to apply to controlled source seismic data from the velocity depth distribution associated with the sensor location.

19. The set of application interface programs according to claim 15 further comprising storing the statics time correction in a form for display.

20. The set of application interface programs according to claim 15 further comprising: a graphical display coupled to the processor and configured to present a view velocity depth distribution.
